(19) United States
(12) Patent Application Publication
(10) Pub. No.: US 2001/0032060 A1
(43) Pub. Date: Oct. 18, 2001

(54) Tracking of clinical study samples, information and results

(76) Inventors: Igor Markidan, Cherry Hill, NJ (US); Himanshu Oberoi, Newton, MA (US); Jerald H. Melnick, Wayland, MA (US)

Correspondence Address: SHERIDAN ROSS P.C., Suite 1200, 1560 Broadway, Denver, CO, 80202-5141, US

(21) Appl. No.: 09/736,619

(22) Filed: Dec. 13, 2000

Related U.S. Application Data
(60) Provisional application No. 60/170,432, filed on Dec. 13, 1999.

(51) Int. Cl. G06F 11/30

(52) U.S. Cl. 702/182

(57) ABSTRACT

A method for the tracking of biological samples and information obtained from those samples during clinical studies is provided. In particular, the present invention provides a method that facilitates the tracking, analysis, and reporting of genotype information derived from biological samples taken from individuals during clinical studies. The method includes recording predetermined characteristics of biological samples in a database, determining procedures to be performed on those samples, determining sample attributes to be recorded, preparing a checklist that includes the procedures and attributes, storing the checklist in the database, performing the procedures and recording the results in the database. The present invention provides an automated system for tracking clinical study protocols, and allows access to information regarding a clinical study to be obtained from a central database. Accordingly, reports regarding the location, chain of custody, test results, and other information concerning samples in a study can be obtained in a highly automated fashion.

### CROSS-REFERENCE TO RELATED APPLICATIONS

This application claims priority under 35 U.S.C. §119(e) from U.S. Provisional application Ser. No. 60/170,432, filed Dec. 13, 1999, which is incorporated herein by reference in its entirety.

### FIELD OF THE INVENTION

The present invention relates to the tracking of samples and information obtained from those samples during clinical studies. In particular, the present invention relates to the tracking, analysis, and reporting of genotype information derived from biological samples taken from individuals participating in clinical studies.

### SUMMARY OF THE INVENTION

Management of information is an important aspect of conducting clinical studies. However, traditional paper based systems that have heretofore been used in such studies suffer from a number of disadvantages. For example, accurate tracking of a sample taken from an individual is difficult because it requires the step that a scientist record on paper the identifier of the sample and all related information produced as that sample progresses through a study. Such a paper based system can result in the loss of crucial information and makes difficult the retrieval of subject attributes and other information concerning individual samples. Auditing of samples from the clinical study and establishing a chain of custody concerning samples is also extremely difficult using paper based systems. In the context of genotyping clinical laboratories, the problems and difficulties associated with paper based tracking systems are magnified. In order to be of use, information for an individual must include genotype information for a desired gene recorded together with medical information about the individual from which the DNA was isolated. Such medical information typically includes age, sex, ethnic background and medical parameters such as cardiovascular statistics, blood pressure and blood analysis. At any one time, hundreds and sometimes thousands of DNA samples can be collected from individuals participating in a clinical study. Thus, accurate tracking of genotype information in an easily retrievable form during a clinical study is extremely complicated and cumbersome when using a traditional paper based system.

The system of the present invention provides for the automated tracking of clinical study protocols, and in particular of genotype information obtained from a clinical study. The system integrates the tracking of individual samples using bar code identifiers and computerized scanners, with checklists of procedures to be performed with respect to each of the samples by scientists. Information regarding the status and location of samples is stored in a central database, allowing for the generation of complete location, chain of custody, test results and other reports in a highly automated fashion. Additionally, the system of the present invention provides for the auditing of laboratory procedures used on samples from clinical studies. Auditing in this context includes, but is not limited to, a complete historical journal of all modifications and changes made to data related to the sample and clinical study after initial entry of sample information.

Additional advantages of the present invention will become readily apparent from the following discussion, particularly when taken together with the accompanying drawings.

### BRIEF DESCRIPTION OF THE DRAWINGS

FIG. 1 is a flow chart of the major process steps of the present invention;

FIG. 2 is a screen shot of a study set up screen according to an embodiment of the present invention;

FIG. 3 is a screen shot of an accessioning screen according to an embodiment of the present invention;

FIG. 4 is a screen shot of a sample tracking screen according to an embodiment of the present invention;

FIG. 5 is a screen shot of a sample worklist according to an embodiment of the present invention;

FIG. 6 is a screen shot of an electronic laboratory procedure checklist according to an embodiment of the present invention;

FIG. 7 is a screen shot of a procedure dialogue according to an embodiment of the present invention;

FIG. 8 is a screen shot of a procedure steps screen according to an embodiment of the present invention;

FIG. 9 is a screen shot of a genotype results screen according to an embodiment of the present invention;

FIG. 10 is a screen shot of an auditing screen according to an embodiment of the present invention; and

FIG. 11 is a screen shot of a reporting screen according to an embodiment of the present invention.

### DESCRIPTION

In accordance with the present invention, a computer-implemented method for tracking: (1) clinical study samples through a clinical study; (2) the progress of a clinical study; and (3) recording the results obtained from procedures conducted during a clinical study is provided. Reference herein to “tracking samples of clinical study” and similar terms can refer to maintenance of the following information regarding samples in a clinical study: patient information from the sample source; physical location of samples; processing done to the sample; and results of procedures done to the sample. The present method is particularly useful for organizing and recording genotype information from a clinical study and long-term management of archives of samples derived from a clinical study. The present invention is particularly useful for clinical studies that use high-throughput activities that generate significant amounts of complex data.

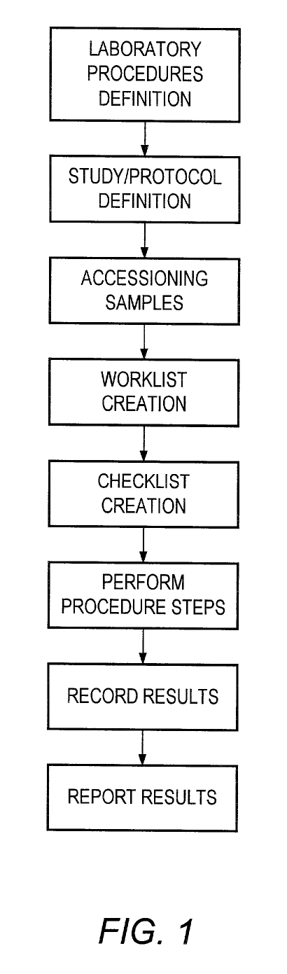

With reference to FIG. 1, the major steps comprising the disclosed method are illustrated. The study is generally initialized by defining the clinical study or protocol including laboratory procedures to be followed. Once these initializing steps have been taken, study samples may be received and accessioned. Worklists assigning individual scientists to conduct specific laboratory procedures on particular samples may be created after the samples have been accessioned. Checklists comprising procedural steps to be completed with respect to associated samples, and generally grouping samples by common procedures found in worklists, may then be created. The scientist then performs each procedural step, and records progress through steps by recording their completion on the checklist. After completion of the indicated procedures for each sample, the scientist then records the results obtained from each step. Following entry of the results, reports may be generated in response to queries. Additional functions, not illustrated in FIG. 1, include sample tracking, which allows the location and condition of samples to be recorded at every stage of the study, and auditing features that allow study directors to confirm that proper procedures have been followed with respect to the samples and monitor the accuracy of changes or corrections made to data as it was initially entered.

Defining a laboratory procedure generally includes describing the steps of the procedure that scientists may be required to perform, and the equipment and products that may be used in connection with the described procedure. In addition, attributes of interest concerning individuals providing samples to the study are identified. Laboratory procedures definition may, in the context of a typical research laboratory, be conducted by laboratory managers.

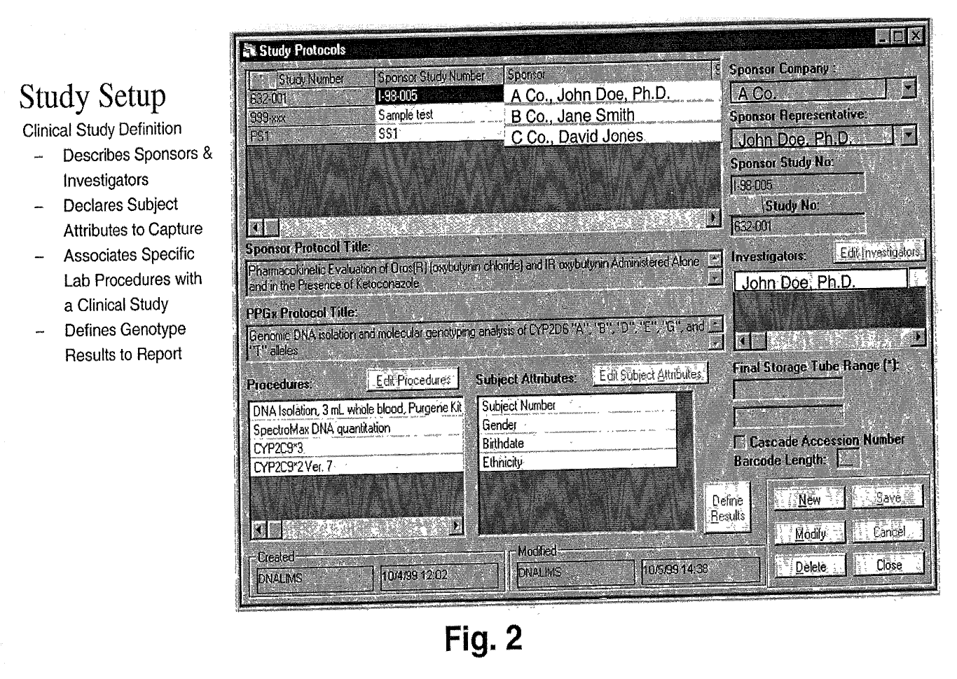

Study protocol definitions may generally include the identification of the sponsor company, sponsor representative, and/or clinical investigator associated with each study protocol. The specific subject attributes to be tracked and/or the terms used to describe those attributes are identified. During study protocol definition, the particular laboratory procedures to be executed as a part of the study are identified, as is the order in which the procedures are to be performed. Additionally, the step of study protocol definition includes defining the genotype information to be reported. A typical screen allowing for entry of information during the step of study protocol definition, according to one embodiment of the present invention, is illustrated in FIG. 2.

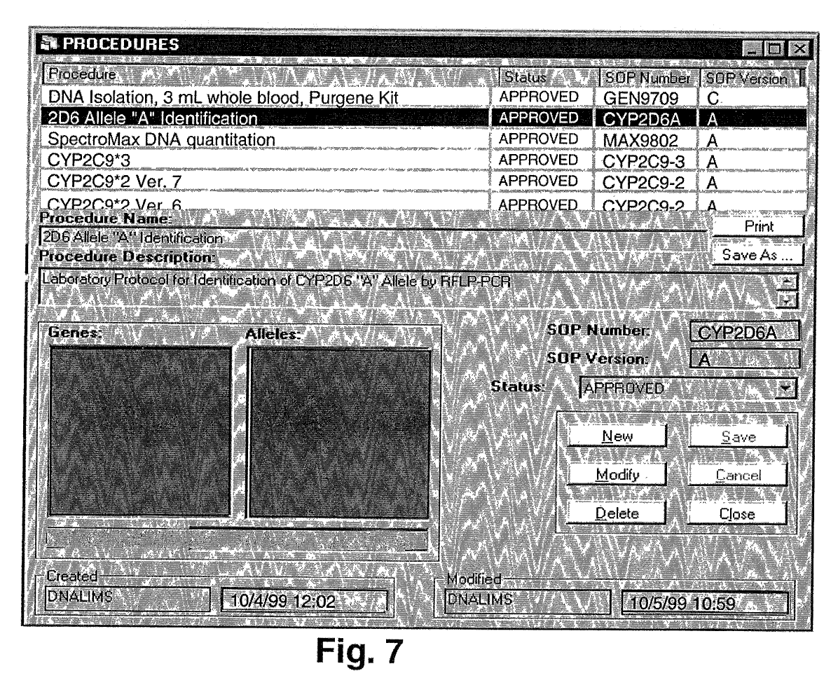

Procedures are definitions which when constructed fully describe the laboratory methods by which a sample must be processed to fulfill a standard operating procedure (SOP) and generally include one or more ordered steps. Where these procedures have been formally approved, they may be referred to as standard operating procedures (SOPs). As illustrated in FIG. 7, a procedure has an identifying name and description. Procedures are also characterized by any gene and/or allele that might be identified by the procedure. Procedures may also include an indication of whether or not the procedure has been formally approved and whether or not it is obsolete.

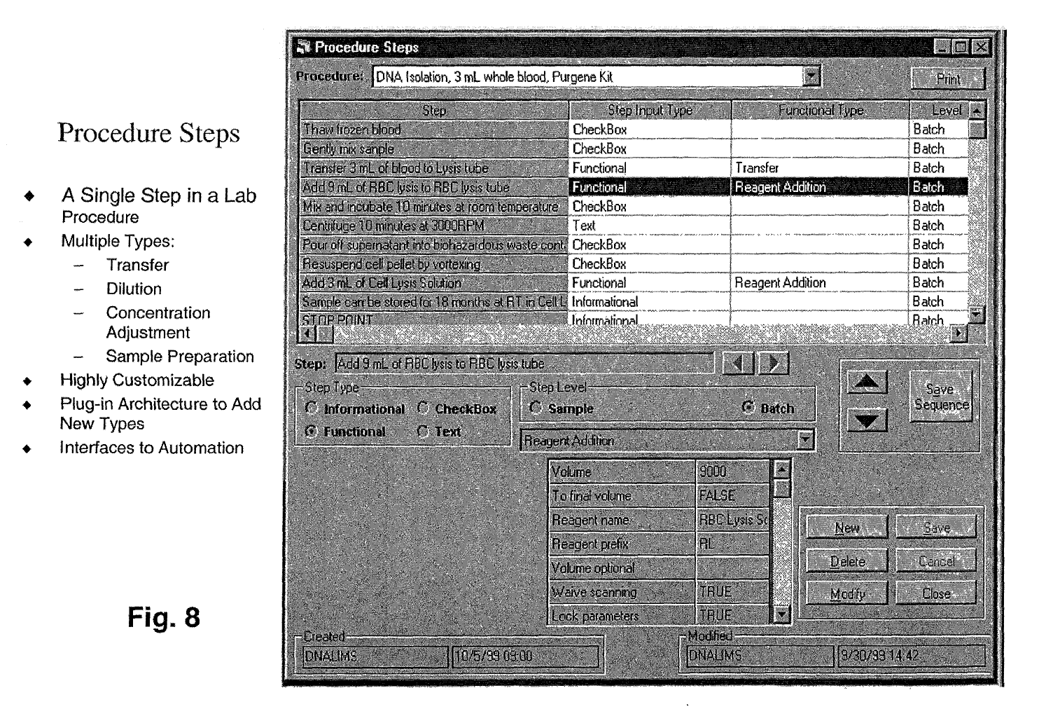

Procedures are defined by their steps, which may be of various types, such as simple laboratory process descriptions with associated check boxes (for acknowledging a process completion, e.g. centrifugation), text boxes (for entering additional information on a process), sample transfers (for recording movement of all or part of a sample from one tube or well of a plate into another), reagent addition steps (for tracking addition of reagents, e.g., oligonucleotides, enzymes or premade mixtures), dilutions (for recording reduction of the concentration of a sample), DNA concentration adjustments, and other sample preparation steps, as illustrated in FIG. 8. According to the system of the present invention, the steps comprising an individual procedure are highly customizable and have provisions for automatic creation and modification. Steps are defined by descriptions of the action a user will need to perform. Steps are also characterized by a “level” which is either individual or batch. If the level is individual, the step must be performed on each sample individually. If the level is batch, the step can be performed on the samples either individually or as a set.

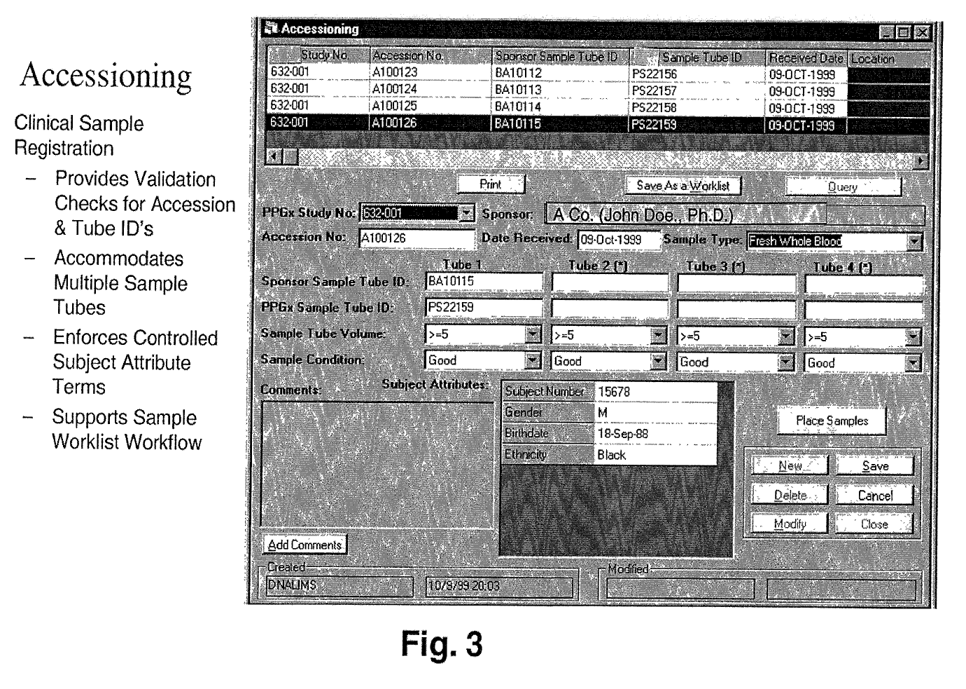

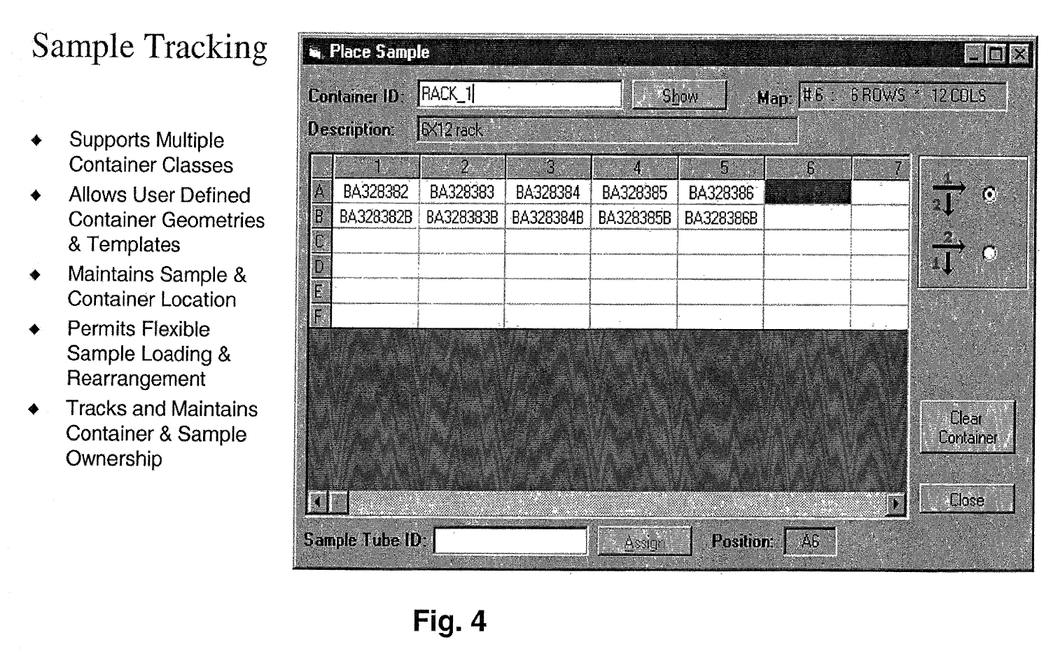

Referring now to FIG. 3, a computer screen according to one embodiment of the present invention, associated with the step of accessioning, is illustrated. Accessioning generally comprises cataloging samples to be used as part of a study into the system. Therefore, accessioning may include the scanning of bar codes assigned to individual samples, associating the particular samples with the study, and recording relevant attributes of the individuals from whom the samples were obtained. Accordingly, the system allows multiple sample tubes taken from the same or different individuals to be registered. By providing for the computerized registration of the samples, a number of benefits are achieved. For example, the system provides validation checks for accession and tube identifiers by ensuring uniqueness and consistency of numeric codes and tube identifiers. In addition, the system enforces the entry of the defined subject attributes of interest. A computer screen for allowing the tracking of individual sample tubes according to one embodiment of the present invention is illustrated in FIG. 4.

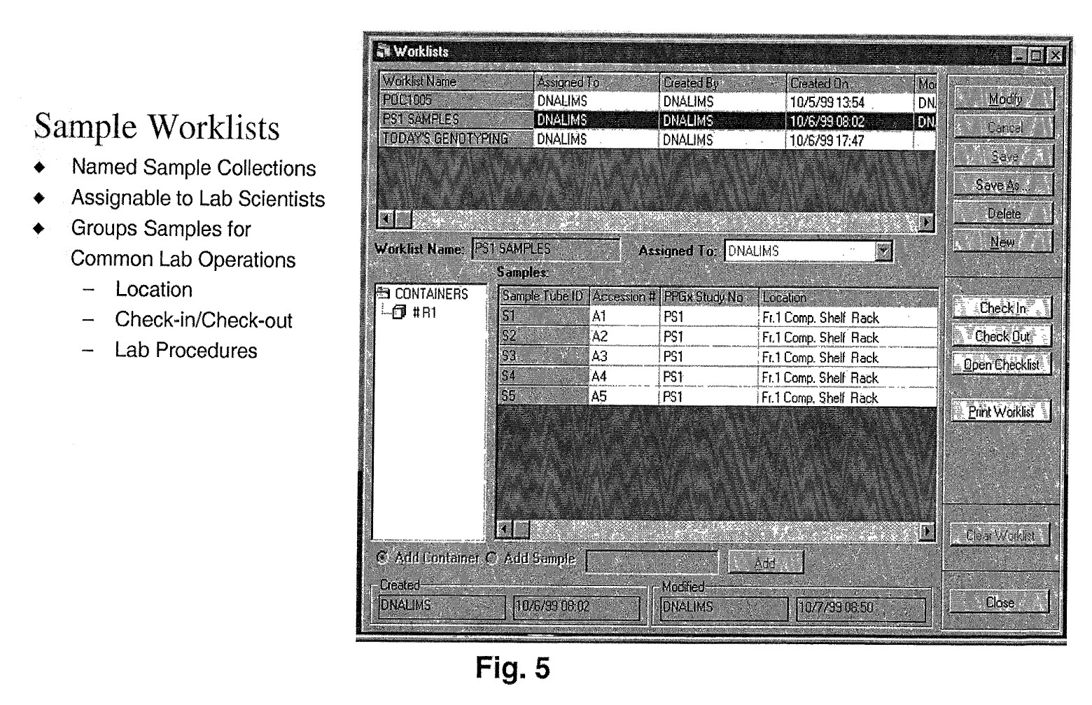

Following the accession of samples, worklists can be created. A computer screen illustrating a sample worklist according to an embodiment of the present invention is illustrated in FIG. 5. The worklist can assign individual samples to particular scientists. This assignment may be performed by individual scientists themselves, or by clinical study directors or other clinical study management personnel. In general, a worklist organizes samples according to a variety of relevant criteria including but not limited to like procedures that are to be performed on them. Thus, different samples requiring analysis using the same procedure can be grouped together and assigned to the same scientist to allow that scientist to process samples in batches, thereby improving the efficiency of the laboratory. The system of the present invention allows samples from multiple studies to be assigned to an individual research scientist. Again, this allows the efficiency of the laboratory to be increased by enabling samples to be processed in batches, while ensuring that the individual samples and data regarding those individual samples are associated with each other and the correct study. As shown in FIG. 5, the worklist typically identifies the location of individual samples, facilitates obtaining consent for use of the samples before permitting procedures to be run on the samples and in so doing ensures that an accurate and detailed chain of custody is maintained.

Through the use of worklists, the system of present invention facilitates the location and tracking of samples such that large numbers of samples maybe accurately and efficiently stored for long term periods in containers, refrigerators, and freezers and later retrieved for additional analysis. These capabilities as described are particularly useful for banking of samples for additional or incremental reprocessing in retrospective or prospective scientific or clinical studies.

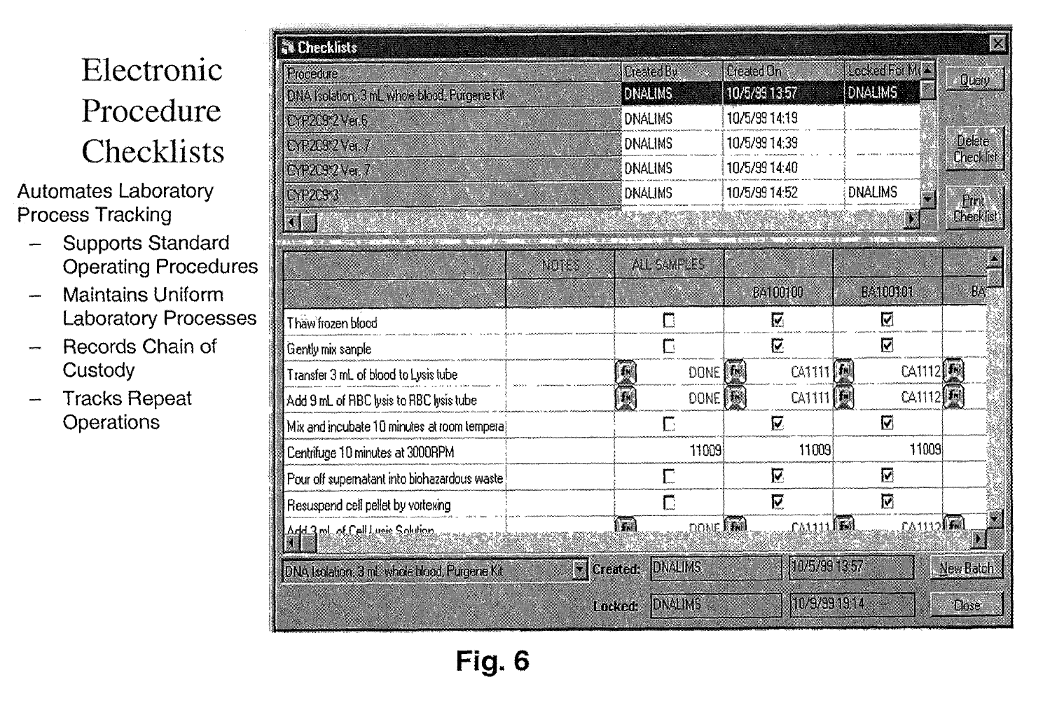

A laboratory procedure checklist according to an embodiment of the present invention is illustrated in FIG. 6. The checklist describes how to perform a given procedure, and identifies samples that are to be processed using that procedure. The checklist may comprise a group of samples from a worklist, and the specific steps of a given procedure that are to be performed on the samples. A checklist is created by identifying the procedure to be conducted and the samples to be used by, for example, scanning in a barcode associated with a container of a given sample to be included in the checklist. No modifications to the steps of a procedure may be specified once a checklist derived from the procedure is populated with one or more samples. Once a procedure has been used as a basis for a checklist, the procedure can only be accessed for viewing.

A checklist is executed by performing each step of a specified procedure for each sample in the checklist. All of the steps of a procedure must be completed sequentially on each sample in the checklist. Thus, the first step of a procedure can be conducted for all of the samples in a checklist, then the second step can be conducted and so forth. Additionally, the checklist provides specific methods defined by the procedure steps to track the processing of samples. One such method is the use of check boxes that require the scientist to check the step off as it is completed, ensuring that the scientist keeps an accurate record of the scientist's progress through the work flow. Complex processes such as the movement of samples, and the separation or combination of samples, are enforced, recorded and tracked using specialized methods with configurable dialogue windows as defined by steps within the checklist. Exchange of data to and from robotics instrumentation may also be directed and managed from specialized steps defined in the procedure checklist. To ensure that identifying information is accurately recorded, and to provide at least partially automated data entry, the samples may be individually identified using a bar code, and that bar code read using a scanner operatively connected to the system. After the processing of an individual sample associated with a checklist is complete, the scientist assigns it a status of “passed” or “failed”. Once all of the samples in a particular checklist have been associated with a status, the checklist is assigned the status of “completed” and can no longer be modified in any way.

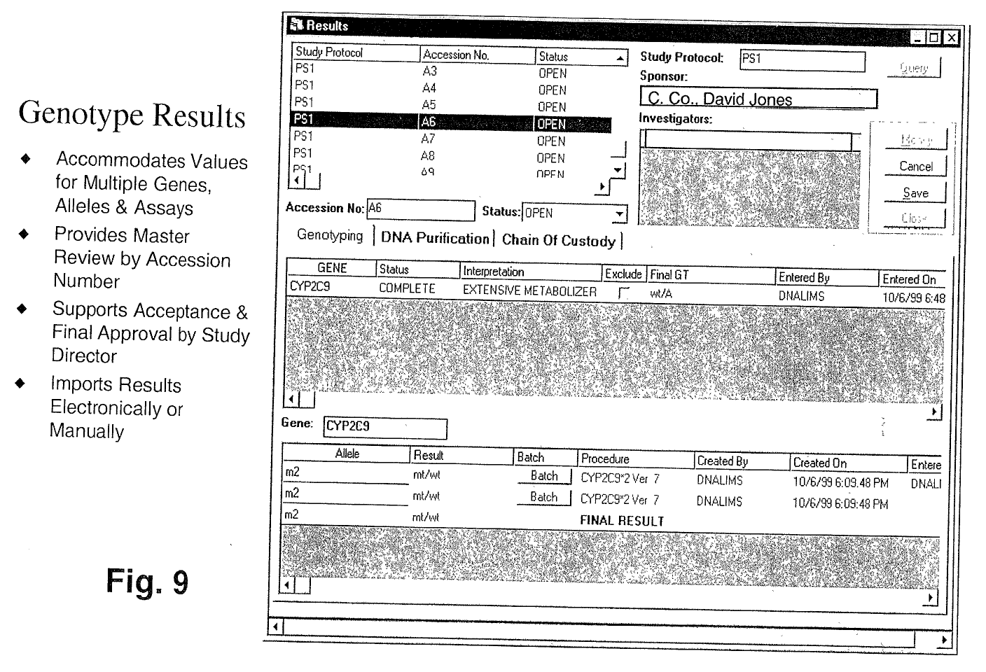

The results of the procedures performed on samples are recorded by the scientist in the checklist window and related interfaces specific to the laboratory technologies employed. In addition, the system of present invention includes an interface to formalize the review of test results such that the results are secured and accessible to the Study Director for the purpose of inspection of results, inspection of chain of custody records, entry of new results, inspection of procedures run and modification or rejection of erroneous results. Final results for an individual in a clinical study are declared final and correct by virtue of completion of results review by the Study Director. Therefore, the system of the present invention provides one integrated system that allows for both the completion of procedural steps and production of records containing the test results. The results of each procedure may then be selectively grouped in response to queries and reports generated. A window according to an embodiment of the present invention illustrating sample genotype results is shown in FIG. 9. When entering information indicating completion of procedure steps which are identified as check box, textual or factual steps, such information can be entered for all samples at one time.

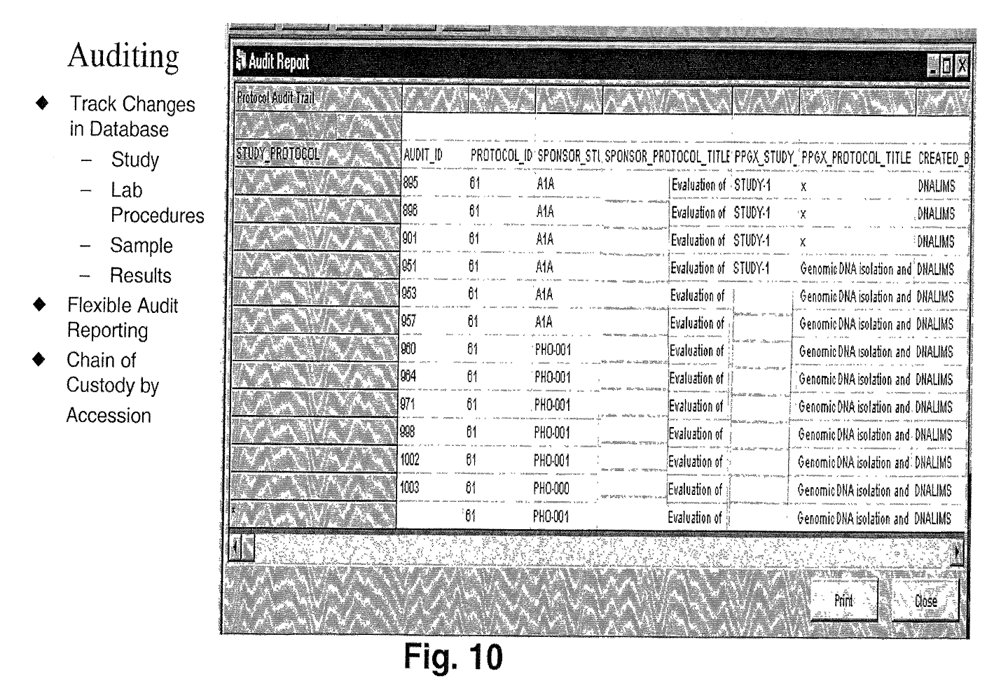

In a preferred embodiment, each of the above-described major steps of the disclosed system are associated with a database that serves as a central repository of the recorded information. Therefore, at every stage of the clinical study, the status and condition of individual samples and all of associated recorded attributes may be accessed from the database. Additionally, the status of procedures performed with respect to the samples may also be accessed. Changes made to the database also are tracked by the system, allowing complete and accurate auditing of samples from clinical studies and associated clinical study protocols. An audit report, according to one embodiment of the present invention, is illustrated in FIG. 10. The information included in an automated audit report may be selected by the user, depending on the parameters of interest.

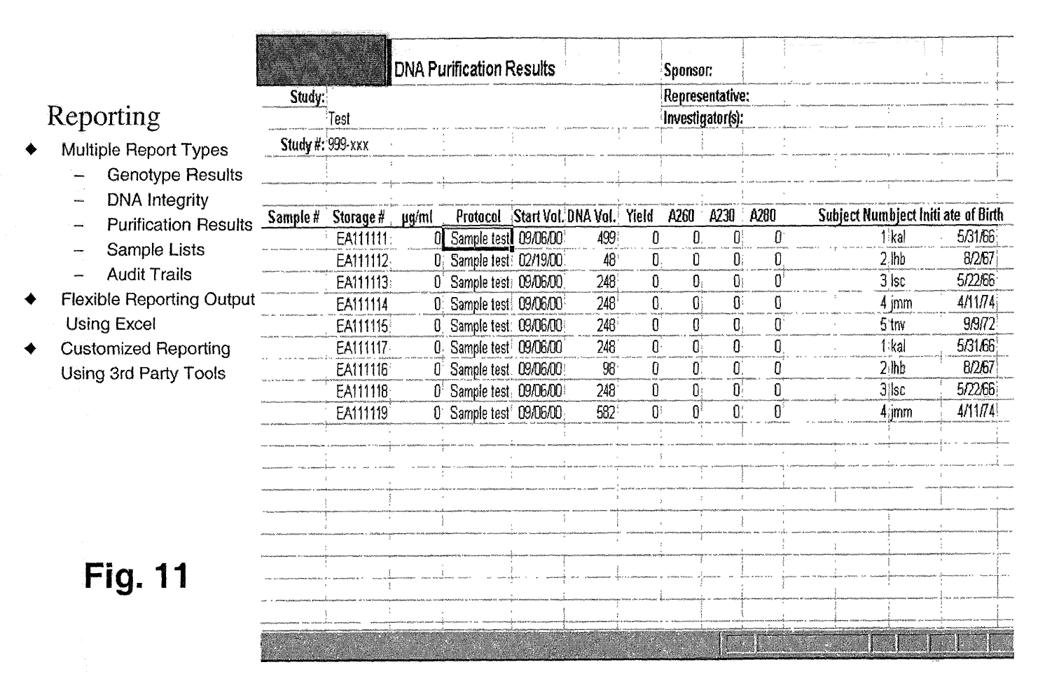

Reports containing results of a clinical study can be easily generated using the disclosed system. An example report according to an embodiment of the present invention is illustrated in FIG. 11. As shown in FIG. 11, reports may include a variety of information. In general, the system generates reports by querying the database in which the clinical study information is recorded, and using the results of the query to populate a spreadsheet. Report types provided for by the system include, but are not limited to, genotype results, DNA integrity, purification results, sample lists, and audit trails. In addition, the system includes other query and search capabilities. The query feature provides for the identification of specific subsets of samples, such as a subset which includes samples from a given study which were received on a certain date, associated with a given worklist, or stored in a particular container. Using the search capability, scientists can locate the boxes, racks, plates and gels that contain the samples they intend to act on or for which they want more information.

According to one embodiment of the present invention, the disclosed system operates on a client server type computer network. The function of the system maybe provided using any programming language, such as VISUAL BASIC® (Registered trademark of Microsoft Corporation). The database may be any typical database program, such as ORACLE® (Registered trademark of Oracle Corporation), and the spreadsheet may be MICROSOFT® Excel (Registered trademark of Microsoft Corporation).

From the foregoing description, a number of unique aspects of the disclosed method are illustrated. The method tracks information about clinical study protocols, the samples collected in conjunction with those protocols, the procedures used to analyze samples, and the results obtained from analysis of samples from a clinical study. The method also helps laboratory personnel that produce genotype information ensure that they adhere to study requirements and good laboratory practices regulations and that they manage and document their work in efficient and effective manner. The method also allows for archiving and efficient retrieval of samples and their related information.

While various embodiments of the present invention have been described in detail, it is apparent that modifications and adaptations of those embodiments will occur to those skilled in the art. It is to be expressly understood, however, that such modifications and adaptations are within the scope of the present invention, as set forth in the following claims.

What is claimed is:

1. A method for tracking samples of a clinical study, comprising:
defining a first clinical study protocol comprising a plurality of procedures, wherein said procedures comprise steps;
accessioning samples for said first clinical study protocol by recording in a database identifying information for said samples and identification of said first clinical study;
creating a worklist by assigning a particular scientist to perform a particular procedure on particular samples;
creating a checklist comprising steps of at least one procedure to be performed on the samples of a worklist;
performing said steps of said checklist; and
recording in said database completion and results of at least a portion of said steps on said checklist.

2. The method of claim 1, further comprising conducting the steps of said method with regard to a second clinical study protocol, wherein said step of accessioning samples includes associating at least a first sample with said first clinical study protocol and at least a second sample with said second clinical study protocol, and wherein at least one worklist assigned to a particular scientist comprises at least one sample associated with said first clinical study protocol and at least a second sample associated with said second clinical study protocol.

3. The method of claim 1, wherein said step of indicating completion and results of at least a portion of said steps on said checklist comprises indicating completion of at least one step for all samples on a checklist by one entry of information.

4. The method of claim 1, wherein at least one of said procedures determines the genotype of an individual.

5. The method of claim 1, further comprising formalization of said results by an activity selected from the group consisting of: inspection of results; inspection of chain of custody records; entry of new results; inspection of procedures run; and modification and rejection of erroneous results.

6. A computer implemented method for tracking samples of a clinical study, comprising the steps of:
providing a computer having an associated memory;
providing a list of standard operating procedures, wherein each of said standard operating procedures comprise procedure steps;
providing a list of samples; and
merging said list of standard operating procedures with said list of samples to generate a check list for use in connection with said clinical study, wherein said list of standard operating procedure, said list of samples and said checklist are all stored in said computer memory.

7. The method of claim 6, wherein at least one of said procedures determines the genotype of an individual.

8. A computer implemented method for tracking samples of a clinical study, comprising:
providing a computer;
accessioning a plurality of samples, wherein identifying information is stored in said computer;
determining procedures to be taken with respect to said samples, wherein said procedures comprise a plurality of steps;
defining at least a first workgroup comprising at least a first of said plurality of samples, wherein said first workgroup comprises at least one procedure, and wherein said workgroup is stored in said computer;
preparing at least one checklist comprising said at least a first workgroup and said steps comprising said at least one procedure, wherein said checklist is stored in said computer;
performing said steps; and
recording performance of said steps in said computer.

9. The method of claim 8, wherein at least one of said procedures determines the genotype of an individual.
